(19) United States
(12) Patent Application Publication
(10) Pub. No.: US 2013/0157510 A1
(43) Pub. Date: Jun. 20, 2013

(54) ELECTRICAL CONNECTOR

(71) Applicants: Ya-Hui Hsu, New Taipei City (TW); Hui-Wen Liu, New Taipei City (TW)

(72) Inventors: Ya-Hui Hsu, New Taipei City (TW); Hui-Wen Liu, New Taipei City (TW)

(73) Assignee: PROCONN TECHNOLOGY CO., LTD., New Taipei City (TW)

(21) Appl. No.: 13/325,419

(22) Filed: Dec. 14, 2011

(51) Int. Cl. H01R 24/28

(52) U.S. Cl. 439/626

(57) ABSTRACT

An electrical connector adapted for electrically connecting with an electronic element includes an insulating housing and a plurality of terminals. The insulating housing defines a plurality of terminal grooves penetrating through a top face thereof. A plurality of convex blocks protrudes upward and is arranged regularly on the top face of the insulating housing. The terminals are received in the terminal grooves of the insulating housing. Each terminal has a contact portion projecting upward beyond the top face of the insulating housing from the terminal grooves for contacting with the electronic element. Tops of the contact portions are further higher than a plane determined by peaks of the convex blocks to ensure the contact portions of the terminals can be pressed down by the electronic element until the convex blocks resist against the electronic element.

### BACKGROUND OF THE INVENTION

1. Field of the Invention

The present invention generally relates to an electrical connector, and more particularly to an electrical connector having a better electrical performance.

2. The Related Art

Referring to FIG. 7, a conventional electrical connector 200 includes an insulating housing 40 and a plurality of terminals 50. The insulating housing 40 defines a plurality of terminal grooves 41 extending vertically to pass through a top face of the insulating housing 40. The terminals 50 are received in the terminal grooves 41 with contact portions 51 of the terminals 50 projecting beyond the top face of the insulating housing 40 through the terminal grooves 41. However, when the electrical connector 200 is in use, the contact portions 51 of the terminals 50 are apt to be overly pressed down to deform the terminals 50. As a result, an electrical performance of the electrical connector 200 is affected, and using life of the electrical connector 200 is shortened accordingly.

### SUMMARY OF THE INVENTION

An object of the present invention is to provide an electrical connector adapted for electrically connecting with an electronic element includes an insulating housing and a plurality of terminals. The insulating housing defines a plurality of terminal grooves penetrating through a top face thereof. A plurality of convex blocks protrudes upward and is arranged regularly on the top face of the insulating housing. The terminals are assembled in the terminal grooves of the insulating housing. Each terminal has a contact portion projecting upward beyond the top face of the insulating housing through the terminal groove for contacting with the electronic element. Tops of the contact portions are further higher than a plane determined by peaks of the convex blocks to ensure the contact portions of the terminals can be pressed down by the electronic element until the convex blocks resist against the electronic element.

As described above, the convex blocks resist against the electronic element for preventing the contact portions of the terminals from being overly pressed down by the electronic element to deform the terminals in the process of the electronic element being put on the insulating housing so as to assure a better electrical performance of the electrical connector and further extend using life of the electrical connector.

### BRIEF DESCRIPTION OF THE DRAWINGS

The present invention will be apparent to those skilled in the art by reading the following description, with reference to the attached drawings, in which:

FIG. 1 is a perspective view of an electrical connector in accordance with the present invention;

FIG. 2 is an exploded view of the electrical connector of FIG. 1;

FIG. 3 is a perspective view of an upper insulating housing of the electrical connector of FIG. 2;

FIG. 4 is a partially perspective view showing that terminals are assembled in a lower insulating housing of the electrical connector of FIG. 1;

FIG. 5 is a side view of the electrical connector of FIG. 1;

FIG. 6 is a sectional view showing that an electronic element is pressed on the terminals of the electrical connector of FIG. 1; and

FIG. 7 is a perspective view of a conventional electrical connector.

### DETAILED DESCRIPTION OF THE PREFERRED EMBODIMENT

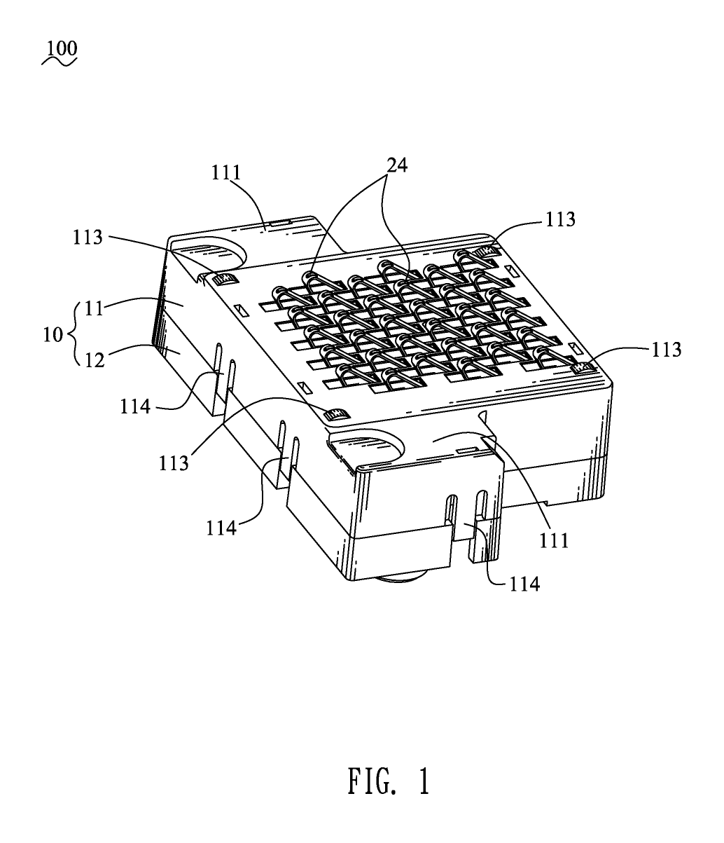

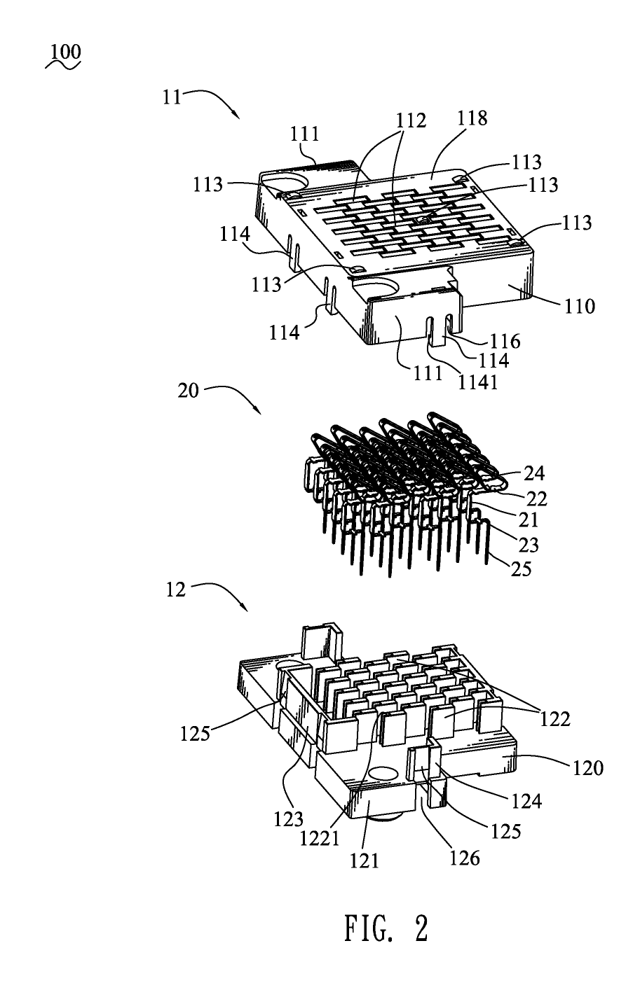

With reference to FIG. 1, FIG. 2 and FIG. 6, an electrical connector 100 in accordance with the present invention is shown. The electrical connector 100 adapted for electrically connecting with an electronic element 30 includes an insulating housing 10 and a plurality of terminals 20.

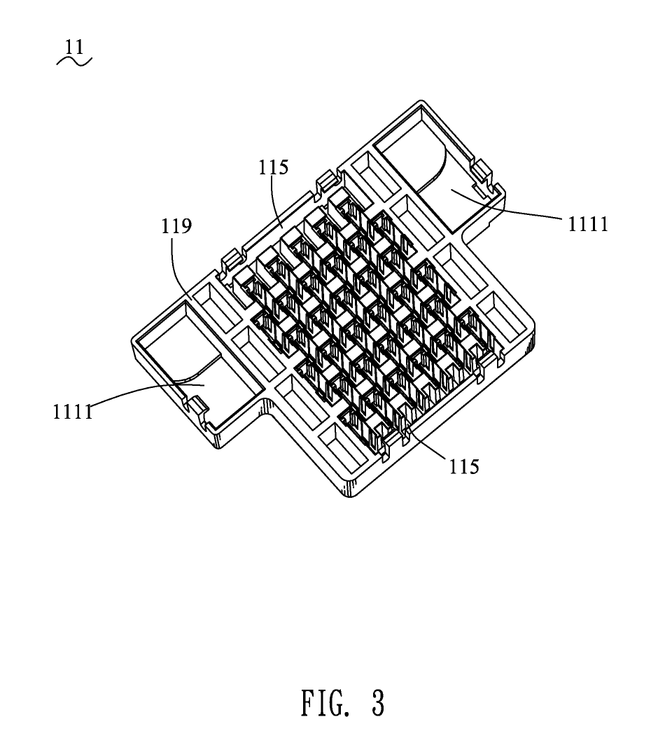

Referring to FIG. 1, FIG. 2 and FIG. 3, the insulating housing 10 includes an upper insulating housing 11 and a lower insulating housing 12. The upper insulating housing 11 has a first base body 110. Two rears of two opposite sides of the first base body 110 extend outward to form two flanks 111. The first base body 110 defines a plurality of terminal grooves 112 array arranged and extending vertically to penetrate through the first base body 110. Four corners and a center of a top face 118 of the first base body 110 protrude upward to form a plurality of convex blocks 113. Each of the convex blocks 113 has a top surface showing an arc shape. A bottom of a periphery of the upper insulating housing 11 defines a plurality of gaps 116 vertically passing therethrough. A top side of each gap 116 extends downward to form a buckling portion 114. A bottom of the buckling portion 114 is bent inward to form a barb 1141. A bottom face 119 of the upper insulating housing 11 defines two receiving spaces 1111 in the two flanks 111 and two fastening slots 115 at two opposite ends thereof.

Referring to FIG. 1 and FIG. 2, the lower insulating housing 12 matched with the upper insulating housing 11 has a second base body 120. Two rears of two opposite sides of the second base body 120 extend oppositely to form two extending board 121. A plurality of supporting blocks 122 are protruded upward from a top of the second base body 120 and array arranged. The lower insulating housing 12 defines a plurality of through-holes 1221 of which each extends vertically to penetrate through the supporting block 122 and the second base body 120. The lower insulating housing 12 defines two side walls 124 protruding at the two extending boards 121 and two end walls 123 protruding at two opposite ends thereof. A plurality of buckling grooves 125 are defined in outer sides of the two side walls 124 and the two end walls 123. Periphery outer sides of the second base body 120 defines a plurality of openings 126 of which each is located under the corresponding buckling groove 125.

Referring to FIG. 2, each of the terminals 20 has a base portion 21 disposed vertically. Two opposite ends of the base portion 21 are bent towards a same direction to form a top supporting portion 22 and a bottom supporting portion 23, respectively. The top supporting portion 22 is longer than the bottom supporting portion 23. A free end of the top supporting portion 22 is connected with an inverted V-shaped contact portion 24 with an opening facing the top supporting portion 22. A free end of the bottom supporting portion 23 extends vertically to form a soldering portion 25.

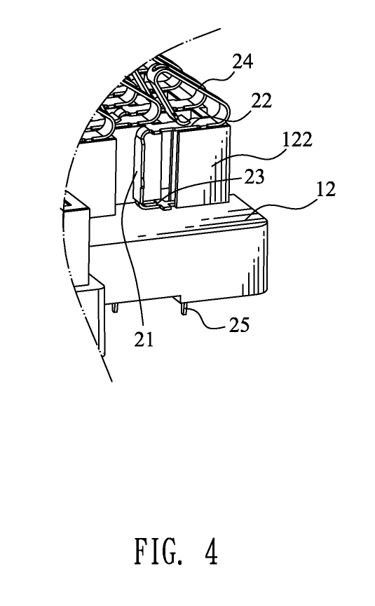

Referring to FIGS. 1-6, when the electrical connector 100 is assembled, the terminals 20 are assembled upward to the terminal grooves 112 of the upper insulating housing 11. The base portions 21 and the top supporting portions 22 are located in the terminal grooves 112. Top portions of the contact portions 24 project upward beyond the top face 118 of the first base body 110 through the terminal grooves 112 for contacting with the electronic element 30. The bottom supporting portions 23 and the soldering portions 25 are exposed under the first base body 110. Tops of the top portions of the contact portions 24 of the terminals 20 are further higher than a plane determined by peaks of the convex blocks 113 to ensure the contact portions 24 of the terminals 20 can be pressed down by the electronic element 30 until the convex blocks 113 resist against the electronic element 30. Then the lower insulating housing 12 is assembled to a bottom of the upper insulating housing 11. The supporting blocks 122 are received in the terminal grooves 112. The two side walls 124 are received in the receiving space 1111 and the two end walls 123 are fastened in the fastening slots 115. The buckling portions 114 are buckled in the buckling grooves 125 with the barbs 1141 located in the openings 126 and hooking bottoms of inner walls of the buckling grooves 125. Meanwhile, the top supporting portion 22 is located on a top surface of the supporting block 122. The bottom supporting portion 23 is located on the top of the second base body 120. The soldering portion 25 passes through the through-hole 1221 to partially project under the second base body 120 for being soldered on a circuit board (not shown).

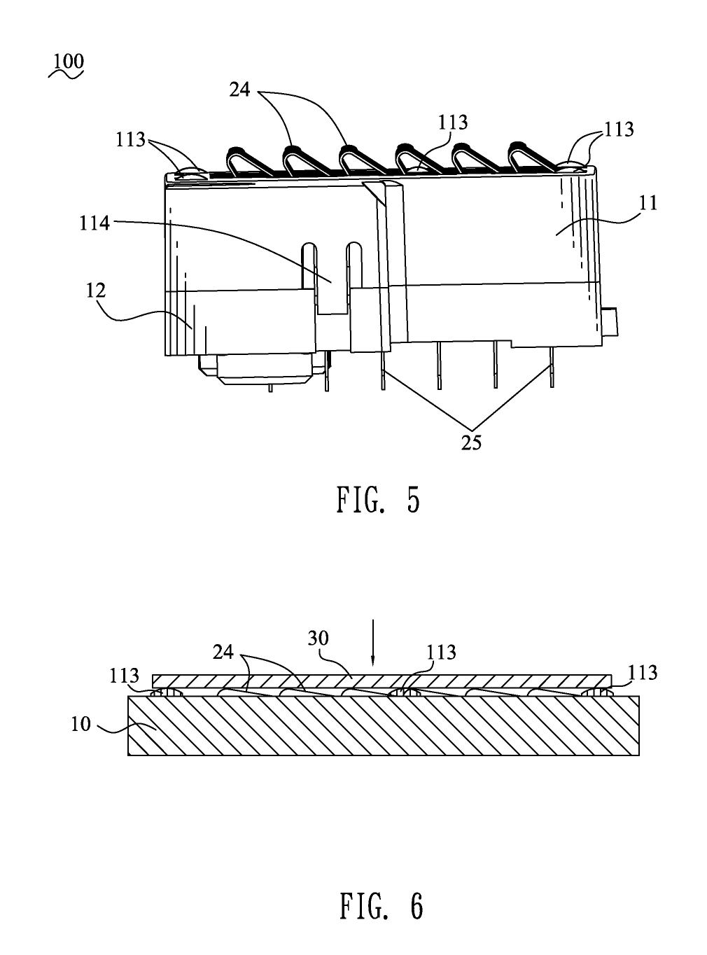

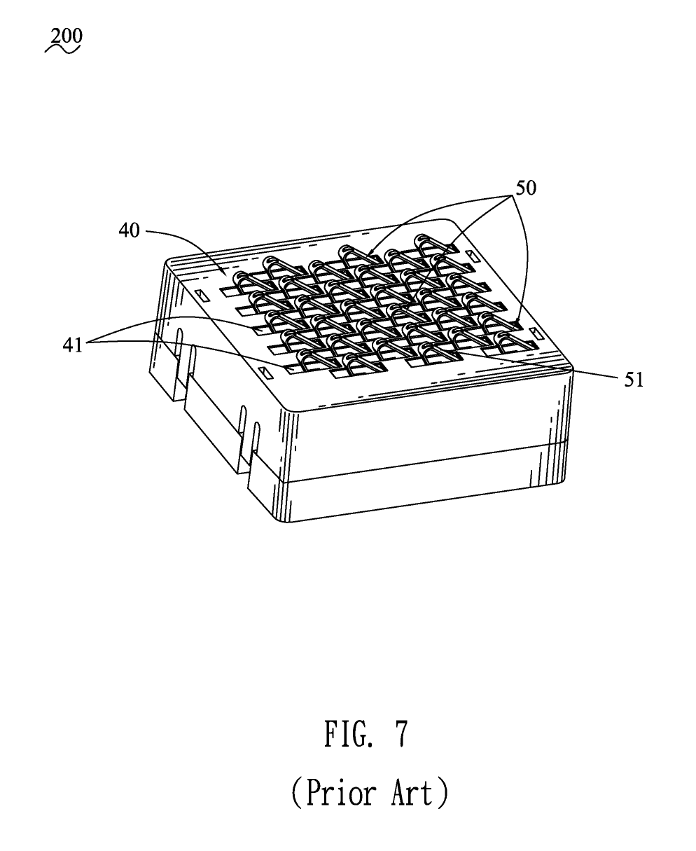

Referring to FIG. 1, FIG. 2, FIG. 5 and FIG. 6, in use, the electronic element 30 is put on the upper insulating housing 11 to press down the top portions of the contact portions 24 of the terminals 20 until the convex blocks 113 resist against the electronic element 30. At the same time, an electrical connection is realized between the electronic element 30 and the contact portions 24 of the terminals 20. The convex blocks 113 resist against the electronic element 30 to effectively prevent the top portions of the contact portions 24 of the terminals 20 from being overly pressed down by the electronic element 30 to deform the terminals 20.

As described above, the convex blocks 113 resist against the electronic element 30 for preventing the top portions of the contact portions 24 of the terminals 20 from being overly pressed down by the electronic element 30 to deform the terminals 20 in the process of the electronic element 30 being put on the upper insulating housing 11 so as to assure a better electrical performance of the electrical connector 100 and further extend using life of the electrical connector 100.

What is claimed is:

1. An electrical connector adapted for electrically connecting with an electronic element, comprising:
an insulating housing defining a plurality of terminal grooves penetrating through a top face thereof, a plurality of convex blocks protruding upward and being arranged regularly on the top face of the insulating housing; and
a plurality of terminals assembled in the terminal grooves of the insulating housing, each terminal having a contact portion projecting upward beyond the top face of the insulating housing through the terminal groove for contacting with the electronic element, wherein tops of the contact portions are further higher than a plane determined by peaks of the convex blocks to ensure the contact portions of the terminals can be pressed down by the electronic element until the convex blocks resist against the electronic element.

2. The electrical connector as claimed in claim 1, wherein the convex blocks are arranged at four corners and a center of the top face of the insulating housing.

3. The electrical connector as claimed in claim 1, wherein each of the convex blocks has a top surface showing an arc shape.

4. The electrical connector as claimed in claim 1, wherein the insulating housing includes an upper insulating housing and a lower insulating housing matched with the upper insulating housing, the terminal grooves are vertically opened in the upper insulating housing and a top face of the upper insulating housing is namely the one of the insulating housing with the convex blocks protruding thereon, the lower insulating housing has a second base body, a plurality of supporting blocks protrudes upward from a top of the second base body and is inserted in the terminal grooves, the lower insulating housing defines a plurality of through-holes vertically penetrating through the corresponding supporting blocks and the second base body, each of the terminals has a base portion received in the terminal groove, two opposite ends of the base portion bend towards a same direction to form a top supporting portion located on a top surface of the supporting block and a bottom supporting portion located on the top of the second base body, a free end of the top supporting portion is connected with the contact portion of substantially inverted-V shape with an opening facing the top supporting portion, a free end of the bottom supporting portion extends downward to form a soldering portion passing through the through-hole to project under the lower insulating housing.

5. The electrical connector as claimed in claim 4, wherein periphery outer sides of the lower insulating housing define a plurality of buckling grooves, a bottom of a periphery of the upper insulating housing defines a plurality of buckling portions buckled in the buckling grooves, a bottom of the buckling portion is bent inward to form a barb hooking a bottom of an inner wall of the buckling groove.

6. The electrical connector as claimed in claim 5, wherein a bottom face of the upper insulating housing defines two receiving spaces at two opposite sides thereof and two fastening slots at two opposite ends thereof, the bottom of the periphery of the upper insulating housing defines a plurality of gaps, a top side of each gap extends downward to form the buckling portion, the lower insulating housing defines two side walls protruding at two opposite sides thereof and positioned in the receiving spaces, and two end walls protruding at two opposite ends thereof and fastened in the fastening slots, the buckling grooves are defined in outer sides of the two side walls and the two end walls, the periphery outer sides of the lower insulating housing further define a plurality of openings of which each is located under the corresponding buckling groove for receiving the barb of the buckling portion therein.
